(19) United States
(12) Patent Application Publication
(10) Pub. No.: US 2014/0325500 A1
(43) Pub. Date: Oct. 30, 2014

(54) METHOD, SYSTEM, AND COMPUTER-READABLE RECORDING MEDIA FOR UPDATING ELECTRONIC CONTROL UNIT

(71) Applicant: Obigo Inc., Gyeonggi-do (KR)

(72) Inventors: Se Kwon Jang, Gyeonggi-do (KR); Jwa Jin Kim, Seoul (KR); Seung Bok Ryu, Seoul (KR); Eun Jeong Ban, Seoul (KR); Jong Min Moon, Seoul (KR)

(73) Assignee: Obigo Inc., Gyeonggi-do (KR)

(21) Appl. No.: 14/247,213

(22) Filed: Apr. 7, 2014

(30) Foreign Application Priority Data
Apr. 24, 2013 (KR) 10-2013-0045665

(51) Int. Cl. G06F 9/445

(52) U.S. Cl. CPC G06F 8/65
USPC 717/173

(57) ABSTRACT

A method for updating an electronic control unit, includes steps of: (a) allowing an update device of a vehicle to wirelessly connect to an update server, at a request of a user terminal; (b) allowing the update device to download a software update from the update server; and (c) allowing the update device to update the electronic control unit by using the software update. In accordance with the present invention, it is possible to update the electronic control units of the vehicle by using the user terminal wirelessly and conveniently without using the complicated method by using an existing cable, a laptop for update, etc.

### CROSS REFERENCE TO RELATED APPLICATION

This application claims priority to and incorporates herein by reference all disclosure in Korean Patent Application No. 10-2013-0045665 filed Apr. 24, 2013.

### FIELD OF THE INVENTION

The present invention relates to a method, a system, and a computer-readable media for updating an electronic control unit; and more particularly, to the method, the system, and the computer-readable media for allowing a user to update the electronic control unit installed in a vehicle by confirming information on the electronic control unit in use of a user terminal such as smartphone or smart pad, requesting any update and downloading a software update from a server.

### BACKGROUND OF THE INVENTION

Today, cars have a variety of electronics and lots of electronic control units for electronic control in cars. Such electronic control units require a lot of software, which gradually has high possibility of errors. Seen from plenty of car errors and recalls that have occurred recently, great parts of them are caused by errors in the software such as electronic control units and their updates become more important.

For such necessities, a method for updating the electronic control units is provided for recent cars. In general, a method for updating the electronic control units by connecting a laptop with an exclusive cable has been widely known. However, such a method had difficulties in enabling consumers to update software because service technicians with expertise should do at an exclusive service center where there is a laptop with software updates. Accordingly, it is difficult for consumers to update the electronic control units of the cars, which have problems, easily and conveniently and if there is any serious problem, auto makers mostly take a method for updating directly through recalls.

To remove such inconvenience, Korean Patent Laid-Open Publication No. 10-2006-0044228 “System and Method for Upgrading Firmware of Electronics by Using Smartphone (by LG Electronics Inc.)” and Korean Patent Registration No. 10-1190314 “Firmware Updating System and Method by Using Smartphone App (by Dongeui University)” propose a firmware upgrading system by using a smartphone. However, the conventionally proposed methods should connect a smartphone and an electronic control unit directly by using an exclusive cable, etc., but it is still not easy to directly connect the electronic control units located at several places in the cars. After the data of the electronic control unit to be updated is directly stored in a smartphone, the data is used to update the electronic control unit, but this had the limit that may cause a serious security problem by storing, in the smartphone of a general user, the software of the electronic control unit of the car, for which the safety issue is most significant.

### SUMMARY OF THE INVENTION

It is an object of the present invention to solve all the problems mentioned above.

It is an object of the present invention to provide a method, a system, and a computer-recordable media for allowing a user to download a software update conveniently and update an electronic control unit of a vehicle by using a user terminal without the necessity of using a conventionally complicated method.

In accordance with the present invention, the software of the electronic control unit is not directly stored in a user terminal at its request, and is transmitted immediately to an update device of the vehicle from an update server to perform the update of the electronic control unit in the update device.

In accordance with one aspect of the present invention, there is provided a method for updating an electronic control unit, including steps of: (a) allowing an update device of a vehicle to wirelessly connect to an update server, at a request of a user terminal; (b) allowing the update device to download a software update from the update server; and (c) allowing the update device to update the electronic control unit by using the software update.

In accordance with another aspect of the present invention, there is provided a method for controlling an update of an electronic control unit in a user terminal, including steps of: (a) connecting to an electronic control unit in a vehicle by a user terminal; (b) allowing information on the electronic control unit to be checked; (c) allowing information on a software update stored in an update server to be checked, wherein an update device for updating the electronic control unit is connected to the update server; and (d) allowing a request for downloading the software update or a request for updating the electronic control unit to be transmitted to the updated device if the download or the update is determined to be necessary by referring to the comparison result between the information on the electronic control unit and the information on the software update stored in the update server.

In accordance with still another aspect of the present invention, there is provided a method for transmitting a software update for a vehicle with an electronic control unit, including steps of: storing a software update of an electronic control unit of a vehicle by an update server; making the update server wirelessly connected to the vehicle, if a user requests an update for the electronic control unit and the user is authenticated; and allowing the update server to transmit the software update to the vehicle at the request of the user.

In accordance with still another aspect of the present invention, there is provided a system for updating an electronic control unit, including: a user terminal for displaying information on an electronic control unit of a vehicle and controlling an update of the electronic control unit; an update device, installed in the vehicle, for providing information on the electronic control unit to the user terminal and updating the electronic control unit at a request of the user terminal; and an update server for storing a software update and transmitting the software update to the update device at the request of the user terminal.

In accordance with still another aspect of the present invention, there is provided an update device of a vehicle with an electronic control unit, including; a communication part for performing wired and wireless communications with an update server and a user terminal; a download managing part for downloading and storing a software update from the update server; and an update executing part for updating the electronic control unit by using the software update.

In accordance with still another aspect of the present invention, there is provided a user terminal for controlling a vehicle with an electronic control unit, including: a communication part for performing a wired or wireless communication directly or indirectly with an update server and a vehicle; an information managing part for managing information on a software update transmitted from the update server and information on the electronic control unit from the vehicle; a display part for displaying the information on the electronic control unit; and an input acquiring part for receiving an entry from a user for downloading the software update or updating the electronic control unit.

In accordance with still another aspect of the present invention, there is provided a server for managing a software update for an electronic control unit, including: a communication part for performing a wired or wireless communication directly or indirectly with a vehicle and a user terminal; a software managing part for storing and managing the software update; and a download controlling part for transmitting the software update to the vehicle, if a request for downloading the software update is made.

### BRIEF DESCRIPTION OF THE DRAWINGS

The above and other objects and features of the present invention will become apparent from the following description of preferred embodiments given in conjunction with the accompanying drawings, in which:

FIG. 1 is a drawing illustrating a sketchy configuration of a system for updating an electronic control unit in accordance with an example embodiment of the present invention.

FIG. 2 is a block diagram showing an internal configuration of an update device in accordance with an example embodiment of the present invention.

FIG. 3 is a block diagram showing an internal configuration of a user terminal in accordance with an example embodiment of the present invention.

FIG. 4 represents an example embodiment of a method for displaying information in a display part of the user terminal.

FIG. 5 is a block diagram illustrating an internal configuration of an update server in accordance with an example embodiment of the present invention.

FIG. 6 is a flow chart illustrating an example embodiment of a procedure for updating the electronic control unit in the system in accordance with an example embodiment of the present invention.

### DETAILED DESCRIPTION OF THE PREFERRED EMBODIMENTS

The detailed description of the present invention illustrates specific embodiments in which the present invention may be performed with reference to the attached drawings.

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the present invention, although different, are not necessarily mutually exclusive. For example, a particular feature, structure, or characteristic described herein in connection with one embodiment may be implemented within other embodiments without departing from the spirit and scope of the present invention. In addition, it is to be understood that the location or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

To allow those skilled in the art to the present invention to be carried out easily, the example embodiments of the present invention by referring to attached diagrams will be explained in detail as follows:

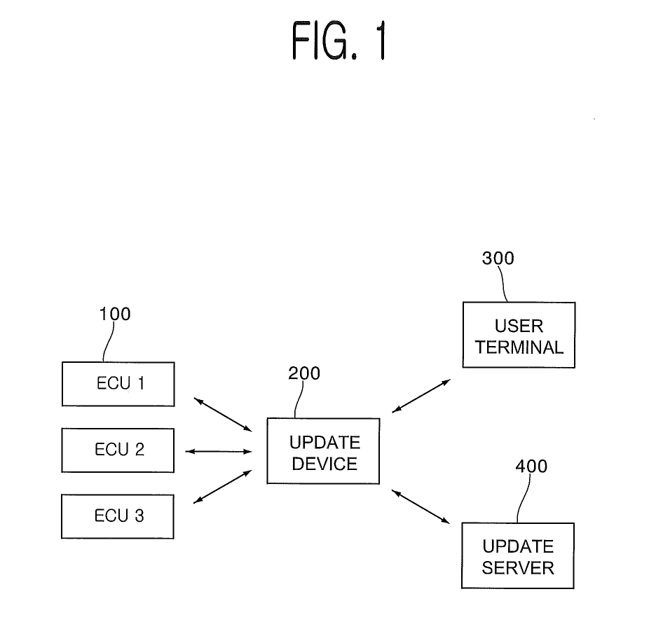

FIG. 1 is a drawing illustrating a sketchy configuration of a system for updating an electronic control unit in accordance with an example embodiment of the present invention.

By referring to FIG. 1, the system for updating the electronic control unit in accordance with an example embodiment of the present invention includes an update device 200, a user terminal 300, and an update server 400 and the update device 200, the user terminal 300, and the update server 400 are connected directly or indirectly with one another by using a communication network (not illustrated). Preferably, the communication network in the present specification may be publicly known Internet or World Wide Web (WWW). But the communication network may include at least part of publicly known wired or wireless data communication networks, telephone networks, or wired or wireless television networks.

In accordance with one example embodiment of the present invention, the update device 200 may be installed in a vehicle, which is used as a term referring to any type of machine which moves such as car, train, or trolley with an engine. The update device 200 is connected with one or more electronic control units 100 installed in the vehicle. For the connection between the update device 200 and the electronic control units 100, a wired communication such as controller area network (CAN), for example, may be used, but it is not limited to this.

The electronic control units 100 mean units for controlling a variety of types of electronic systems embedded in the vehicle. For example, they may include a unit that controls electronics in fuel supply systems, exhaust gas recirculation ratio (or EGR), ignition timing, idling RPM, or other relevant performances. In addition, they may include a self-diagnosis system as a function of detecting a trouble that may occur, such as a system with a function of controlling fuel injection, ignition timing, idle speed, EGR, fuel pump, exhaust gas temperature indicator, and self-diagnosis and the present invention is not limited to the type or function and it is applicable to a variety of updatable electronic control units.

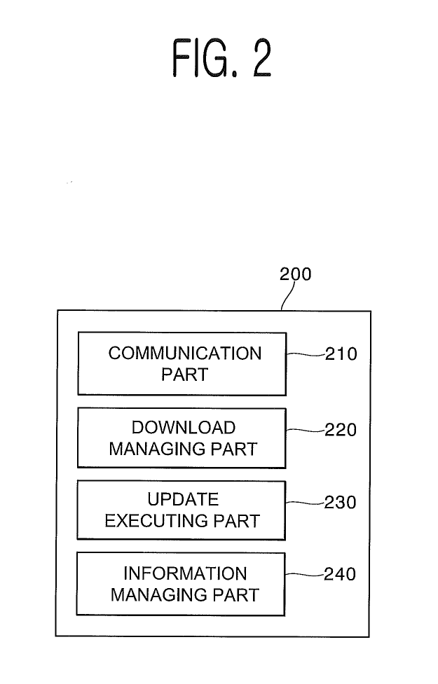

In accordance with one example embodiment of the present invention, the update device 200 performs an update of each electronic control unit 100, if necessary, at the user's request and this will be explained below in detail by referring to FIG. 2.

In accordance with one example embodiment of the present invention, the user terminal 300 means all types of devices that have a function for direct or indirect connection with an update device or a server through a communication network and may include digital devices such as desktops, laptops, palmtops, personal digital assistants (PDA), tablet PCs, web pads, smartphones and other mobile phones.

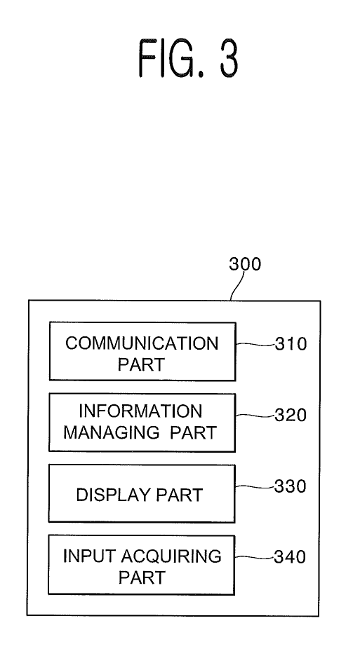

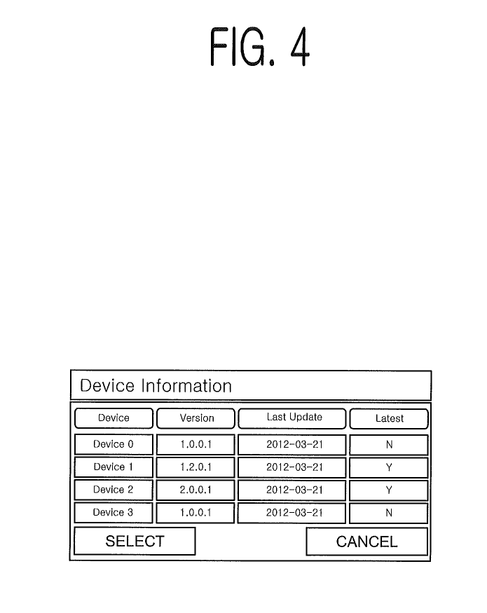

The user terminal 300 in accordance with one example embodiment of the present invention manages and controls the electronic control units through the update device 200. More specifically, it may check information on electronic control units installed in a vehicle and/or latest versions of the electronic control units through the communication with the update device 200, e.g., Wi-Fi, Bluetooth or other wireless communication, and direct to download and/or upload electronic control unit software. Such functions of the user terminal 300 may be embedded therein itself or may be installed by the user in a form of application. In general, the method for installing such app in a smart device such as smartphone or smart pad may be usefully available, and such app may be provided to be downloaded through an appstore or the like. The detailed configuration and functions of the user terminal 300 will be explained below by referring to FIGS. 3 and 4.

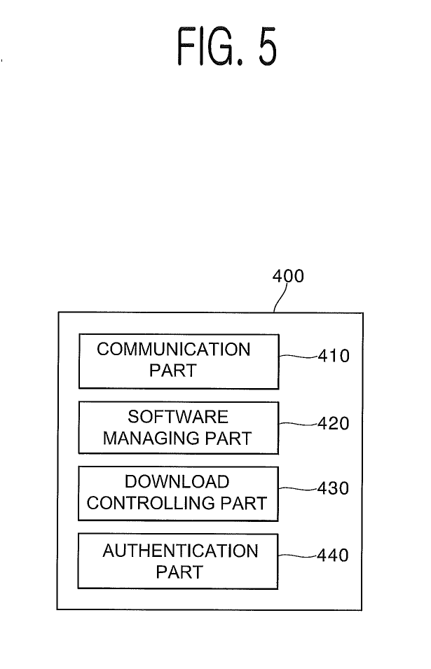

In accordance with the present invention, the update server 400 performs a role of storing and managing software updates of the electronic control units. The update device 200 checks the latest information on the electronic control units from the update server 400, e.g., the information on the latest software version or software distribution date, etc., downloads the latest software for the electronic control units and then updates the electronic control units. The configurations and the functions of the update server 400 will be described below by referring to FIG. 5.

As such, in accordance with the present invention, since the update server 400 transmits software for the electronic control units directly to the update device 200 without having to store the software in the user terminal 300, more security may be ensured by reducing risk of software change in the user terminal 300.

FIG. 2 is a block diagram showing an internal configuration of an update device in accordance with an example embodiment of the present invention.

By referring to FIG. 2, the update device 200 in accordance with one example embodiment of the present invention includes a communication part 210, a download managing part 220, and an update executing part 230 and may further include an information managing part 240.

The communication part 210 performs a communication with the user terminal 300 or the update server 400. A variety of communication methods as explained above are available, and the wireless communication such as Wi-Fi and Bluetooth, typically, may be available. In accordance with an example embodiment of the present invention, it is connected to the update server 400 through the communication part 210 at a request of the user terminal 300.

In accordance with one example embodiment of the present invention, the communication part 210 may be configured to use not only one communication network but also different networks, e.g., Wi-Fi and telecommunication networks such as 3G or LTE. Accordingly, it may be connected to the user terminal 300 or the update server 400 by using Wi-Fi at Wi-Fi hot spots and may widen wireless access cope by using any telecommunication network at any other places.

Meanwhile, the communication part 210 in accordance with another example embodiment of the present invention is configured out of the update device to be connected in a wired or wireless way thereto to operate. At the time, the communication part 210 may be allowed to select the support to connect between a car maker and a pre-contracted telecommunication service provider, if necessary.

In accordance with one example embodiment of the present invention, the download managing part 220 downloads and stores software update from the update server 400. More specifically, the download managing part 220 downloads the software update from the update server 400 at the request from the user terminal 300 and stores the downloaded software update.

In accordance with one example embodiment of the present invention, the update executing part 230 updates the electronic control unit by using the software update stored in the download managing part 220. The execution of the update may be performed at any request from the user terminal. In comparison between the information on the software update stored in the download managing part 220 and the current information on the software of the electronic control unit, if the downloaded software update is the more recent version, the update executing part 230 may perform the update for the electronic control unit.

In accordance with one example embodiment of the present invention, the update device 200 may further include the information managing part 240. The information managing part 240 manages information on the electronic control unit. At the time, the information on the electronic control unit, for example, may include information on whether the electronic control unit is a device whose software can be updated, a version of software installed in the electronic control unit and/or latest updating time, etc.

The information managing part 240 may transmit information on each electronic control unit to the user terminal 300 at the request of the user terminal through the communication part 210. At the time, only the information on updatable electronic control units may be transmitted instead of information on all the electronic control units.

The information managing part 240 may compare information on the electronic control units installed in the vehicle with information on the update server 400. More specifically, for example, whether information on the version of the software installed in the electronic control unit is matched with the information on the latest software update version stored in the update server 400 is checked and when the two versions are matched, the version of the software installed in the electronic control unit may be found to be the latest software. As another example, if the latest updating date of the electronic control unit is later than the distribution date of the latest software update in the update server 400, the version of the software installed in the electronic control unit may be found to be the latest.

FIG. 3 is a block diagram showing an internal configuration of the user terminal 300 in accordance with an example embodiment of the present invention. By referring to FIG. 3, the user terminal 300 in accordance with one example embodiment of the present invention may include a communication part 310, an information managing part 320, a display part 330, and an input acquiring part 340.

The communication part 310 in accordance with one example embodiment of the present invention performs wired or wireless communication directly or indirectly with the update server 400 and the update device 200 installed in the vehicle. The user terminal 300 may receive information on the electronic control unit 100 installed in the vehicle and information on the software update stored in the update server 400 and may transmits a request for download or update of software through the communication part 310. In case of the information on the software update, it may get information managed in the update device 200 and/or information on the result of comparison through the update device 200. In accordance with another example embodiment of the present invention, the user terminal 300 may also request required information after directly connecting to the update server 400.

In accordance with one example embodiment of the present invention, the information managing part 320 manages information on the electronic control unit 100 installed in the vehicle or information on the software update stored in the update server 400. Or it may include information on the comparison result transmitted from the update device 200. Information on electronic control unit, for example, may include whether the electronic control unit is a unit whose software is upgradable, information on the version of the software installed in the electronic control unit, and/or latest update time. The information on software update, for example, may include the latest software version, software distribution date, etc.

In accordance with one example embodiment of the present invention, the information managing part 320 may compare the information on the electronic control unit installed in vehicles with the information on software update. More specifically, when whether the information on the version of the software installed in the electronic control unit and the information on the latest software version stored in the update server are matched is checked, if the two versions are matched, it may be found, for example, that the current version of the software installed in the electronic control unit is the latest. Another example is that if the recently updating date of the software installed in the electronic control unit is the latest in comparison between the latest updating date of the electronic control unit and the distribution date of the latest software update in the update server, it may be found that the version of the software installed in the electronic control unit is the latest. Such comparison may be performed not in the user terminal 300 but in the update device 200 as explained above.

In accordance with one example embodiment of the present invention, the display part 330 may show the information stored in the information managing part 320 to allow the user to confirm whether the download or the update is performed or not. In addition, it may further include the comparison result as explained above to display.

In accordance with one example embodiment of the present invention, the input acquiring part 340 gets a request from the user for download and/or update for a specific electronic control unit. More specifically, after checking the information on the electronic control units through the display part 330, the user may select the specific electronic control unit required for download and/or update to request such download and/or update, which may be conducted separately, if necessary, even though the download and update are generally made consecutively. For example, it is possible to perform the download at a place where the communication network is connectible and store it and then conduct the update later.

The input acquiring part 340 may be embodied as a touch screen and in such a case, the input acquiring part 340 and the display part 330 may be same.

FIG. 4 represents an example embodiment of a method for displaying information in the display part 330 of the user terminal 300. By referring to FIG. 4, the display part 330 may show information on multiple electronic control units in a form of list, and may display information on name or ID, current software version, last update date, whether the current software version is latest, etc. As shown in the example in FIG. 4, it is possible to display only the information on updatable electronic control units and information on whether the electronic control units are updated or not in a separate field.

By referring to FIG. 4 as an example of using a touch screen, the device has the input acquiring part 340 where the user may select or cancel devices for update on the bottom. The user may select one or more electronic control units to download software and/or request for updating electronic control units.

FIG. 5 is a block diagram illustrating an internal configuration of the update server 400 in accordance with an example embodiment of the present invention. By referring to FIG. 5, the update server 400 in accordance with one example embodiment of the present invention may include a communication part 410, a software managing part 420, and a download controlling part 430, and further an authentication part 440.

In accordance with one example embodiment of the present invention, the communication part 410 performs wired and wireless communications directly or indirectly with the vehicle and the user terminal.

In accordance with one example embodiment of the present invention, the software managing part 420 stores and manages the software updates for the electronic control units. The software managing part 420 may store software for one or more electronic control units to manage the information on the software update. The information on the software update, for example, may include latest software version information, software distribution date, etc.

If the request for downloading the specific electronic control unit is made, the download controlling part 430 in accordance with one example embodiment of the present invention transmits the latest version of software, stored in the software managing part 420, of the specific electronic control unit.

To access the update server, the authentication for the user is required, and for this, the authentication part 440 may be further included.

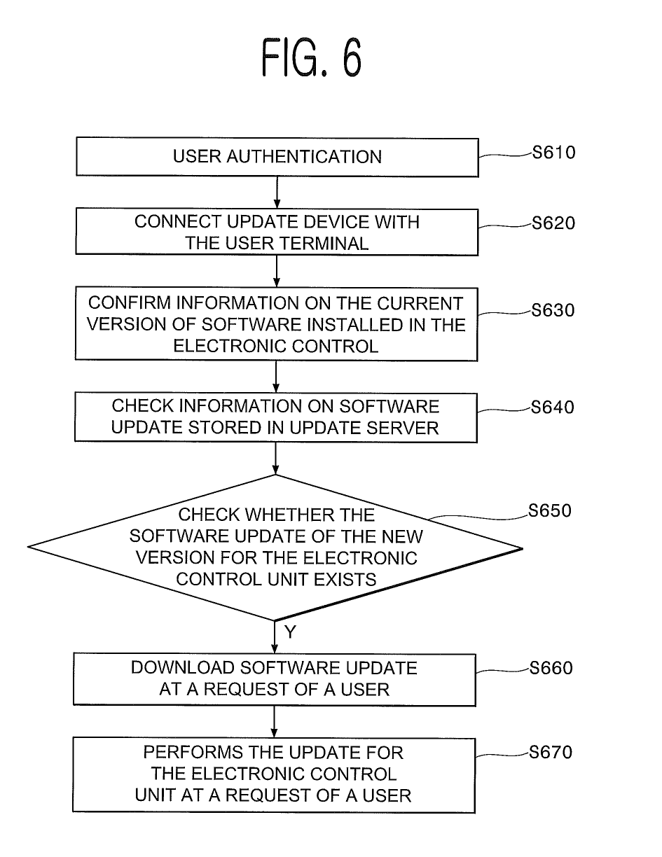

FIG. 6 is a flow chart illustrating an example of a procedure for updating the electronic control unit in the system in accordance with an example embodiment of the present invention.

The user performs user authentication through an application installed in the user terminal 300 (S610). The user turns on the power of the update device 200 installed in the vehicle, and connects it with the user terminal 300 (S620). At the time, the connection with the vehicle may be embodied by a variety of communication methods such as wired connection by using cables, or wireless communication connection like WI-FI, Bluetooth, and Infrared Ray Communication.

The user confirms information on the current state of the electronic control unit through the information displayed in the user terminal 300 (S630). For example, the user may check the current software version, the update date, the latest version, etc.

In addition, the user checks whether a new version of the software for the electronic control unit exists through the access to the update server 400 (S640). If the software update of the new version for the electronic control unit exists (S650), the user transmits the request for download by using the user terminal 300. If the request of the user for download is transmitted, the update server 400 transmits the software update for the electronic control unit requested by the user to the update device and the update device 200 downloads and stores it (S660).

If necessary, the user may select the specific electronic control unit desired to update and then make the update device update it. When the request for update is transmitted from the user terminal 300, the update device 200 performs the update for the electronic control unit by using the downloaded software update (S670).

In accordance with the present invention, it is possible to update the electronic control units of the vehicle by using the user terminal wirelessly and conveniently without using the complicated method by using an existing cable, a laptop for update, etc.

In accordance with the present invention, more security may be achieved by transmitting software directly to the update device in the vehicle from the update server without storing software for the electronic control units directly in the user terminal.

The embodiments of the present invention can be implemented in a form of executable program command through a variety of computer means recordable to computer readable media. The computer readable media may include solely or in combination, program commands, data files and data structures. The program commands recorded to the media may be components specially designed for the present invention or may be usable to a skilled person in a field of computer software. Computer readable record media include magnetic media such as hard disk, floppy disk, magnetic tape, optical media such as CD-ROM and DVD, magneto-optical media such as floptical disk and hardware devices such as ROM, RAM and flash memory specially designed to store and carry out programs. Program commands include not only a machine language code made by a complier but also a high level code that can be used by an interpreter etc., which is executed by a computer. The aforementioned hardware device can work as more than a software module to perform the action of the present invention and they can do the same in the opposite case.

While the invention has been shown and described with respect to the preferred embodiments, it will be understood by those skilled in the art that various changes and modification may be made without departing from the spirit and scope of the invention as defined in the following claims.

Accordingly, the thought of the present invention must not be confined to the explained embodiments, and the following patent claims as well as everything including variation equal or equivalent to the patent claims pertain to the category of the thought of the present invention.

What is claimed is:

1. A method for updating an electronic control unit, comprising steps of:
(a) allowing an update device of a vehicle to wirelessly connect to an update server, at a request of a user terminal;
(b) allowing the update device to download a software update from the update server; and
(c) allowing the update device to update the electronic control unit by using the software update.

2. The method of claim 1, further comprising a step of: transmitting information on the electronic control unit to the user terminal connected to the vehicle.

3. The method of claim 2, wherein the information on the electronic control unit includes at least a piece of updatability, software version, and latest update time of the electronic control unit.

4. The method of claim 2, wherein the vehicle has one or more electronic control units and the information on the electronic control unit includes information on an updatable electronic control unit among one or more electronic control units.

5. The method of claim 1, wherein the step (b) is to be executed at a request for download transmitted from the user terminal connected to the vehicle.

6. The method of claim 1, wherein the step (c) is to be executed at a request for download transmitted from the user connected to the vehicle.

7. The method of claim 1, wherein the vehicle and the user terminal are connected by using a wireless communication network.

8. A method for controlling an update of an electronic control unit in a user terminal, comprising steps of:
(a) connecting to an electronic control unit in a vehicle by a user terminal;
(b) allowing information on the electronic control unit to be checked;
(c) allowing information on a software update stored in an update server to be checked, wherein an update device for updating the electronic control unit is connected to the update server; and
(d) allowing a request for downloading the software update or a request for updating the electronic control unit to be transmitted to the updated device if the download or the update is determined to be necessary by referring to the comparison result between the information on the electronic control unit and the information on the software update stored in the update server.

9. The method of claim 8, further comprising steps of: displaying the information on the electronic control unit by the user terminal; and receiving an entry for executing the download or the update from a user.

10. The method of claim 9, wherein the vehicle has at least one electronic control unit and the information on the electronic control unit is displayed for an updatable electronic control unit among the at least one electronic control unit, and the request for the download or the request for the update is made for a specific electronic control unit which is selected by the user.

11. The method of claim 8, wherein the information on the electronic control unit includes at least one piece of information on updatability, software version, and latest update time of the electronic control unit.

12. The method of claim 8, further comprising a step of: comparing the information on the electronic control unit with the information on the software update.

13. The method of claim 12, wherein the step of comparing includes determining whether information on a version of a software installed in the electronic control unit and information on the latest version of the software update stored in the update server are matched.

14. The method of claim 8, further comprising a step of: performing user authentication.

15. A method for transmitting a software update for a vehicle with an electronic control unit, comprising steps of:
storing a software update of an electronic control unit of a vehicle by an update server;
making the update server wirelessly connected to the vehicle, if a user requests an update for the electronic control unit and the user is authenticated; and
allowing the update server to transmit the software update to the vehicle at the request of the user.

16. The method of claim 15, further comprising a step of: managing a version of the software update.

17. The method of claim 15, further comprising a step of: transmitting the information on the software update to the user.

18. A system for updating an electronic control unit, comprising:
a user terminal for displaying information on an electronic control unit of a vehicle and controlling an update of the electronic control unit;
an update device, installed in the vehicle, for providing information on the electronic control unit to the user terminal and updating the electronic control unit at a request of the user terminal; and
an update server for storing a software update and transmitting the software update to the update device at the request of the user terminal.

19. The system of claim 18, wherein the user terminal receives the information on the stored software update and displays comparison result between the information on the stored software update and the information on the electronic control unit.

20. The system of claim 18, wherein the update device downloads and stores the software update from the update server at a request of the user terminal.

21. An update device of a vehicle with an electronic control unit, comprising;
a communication part for performing wired and wireless communications with an update server and a user terminal;
a download managing part for downloading and storing a software update from the update server; and
an update executing part for updating the electronic control unit by using the software update.

22. The update device of claim 21, further comprising: an information managing part for storing and transmitting information on the electronic control unit to the user terminal.

23. The update device of claim 22, wherein the information on the electronic control unit includes at least one piece of updatability, software version, and latest update time of the electronic control unit.

24. The update device of claim 21, wherein the download managing part downloads and stores the software update at a request for the download from the user terminal.

25. The update device of claim 21, wherein the update executing part updates the electronic control unit at a request for the update from the user terminal.

26. A user terminal for controlling a vehicle with an electronic control unit, comprising:
a communication part for performing a wired or wireless communication directly or indirectly with an update server and a vehicle;
an information managing part for managing information on a software update transmitted from the update server and information on the electronic control unit from the vehicle;
a display part for displaying the information on the electronic control unit; and
an input acquiring part for receiving an entry from a user for downloading the software update or updating the electronic control unit.

27. The user terminal of claim 26, wherein the information managing part compares the information on the software update and the information on the electronic control unit and the display part further displays the comparison result.

28. A server for managing a software update for an electronic control unit, comprising:
a communication part for performing a wired or wireless communication directly or indirectly with a vehicle and a user terminal;
a software managing part for storing and managing the software update; and
a download controlling part for transmitting the software update to the vehicle, if a request for downloading the software update is made.

29. The server of claim 28, further comprising: an information managing part for storing, and transmitting to the user terminal, the information on the software update.

30. The server of claim 28, further comprising: an authentication part for performing authentication for the user terminal.
